(19) United States
(12) Patent Application Publication
(10) Pub. No.: US 2014/0018713 A1
(43) Pub. Date: Jan. 16, 2014

(54) PERSONAL VIBRATION APPLIANCE

(71) Applicant: Resonant Systems, Inc., Seattle, WA (US)

(72) Inventors: Robin Elenga, Seattle, WA (US); Brian Pepin, Oakland, CA (US); Glen Tompkins, Woodinville, WA (US)

(73) Assignee: Resonant Systems, Inc., Seattle, WA (US)

(21) Appl. No.: 13/935,692

(22) Filed: Jul. 5, 2013

Related U.S. Application Data
(60) Provisional application No. 61/668,391, filed on Jul. 5, 2012.

(51) Int. Cl. A61H 23/02

(52) U.S. Cl. CPC A61H 23/0218
USPC 601/78

(57) ABSTRACT

The current disclosure is directed to personal vibration appliances, operated either by battery power or wall power, that incorporate a linear-vibration module to generate vibration with frequencies below 40 Hz, between 40 Hz and 110 Hz, and above 110 Hz with forces up to and beyond 15 g. In certain implementations, the frequency and force of vibration may be independently controlled. In certain implementations, the vibrational frequency and/or vibrational power may be correlated to various additional signals, both internal and external, including audio sound signals, light signals, and audiovisual signals. In certain implementations, the vibration appliance features an interchangeable massage piston with interchangeable massage tips and other accessories. Finally, operational characteristics of the personal vibration appliances may be modified by various types of sensor and other feedback signals.

### CROSS-REFERENCE TO RELATED APPLICATION

This application claims benefit of Provisional Application No. 61/668,391, filed Jul. 5, 2012.

### TECHNICAL FIELD

The current application is related to personal vibration appliances and, in particular, to personal vibration appliances that employ linear-vibration modules.

### BACKGROUND

Electric vibrators are used in a wide variety of different applications, including for therapeutic and non-therapeutic massage, topical and penetrating stimulation, cleaning and surface conditioning, and many other types of applications. Currently available electric vibrators are, however, limited in both vibration-frequency range and in vibration-power range.

The majority of currently available electric vibrators generate vibration using an eccentrically mounted weight on the shaft of a rotary electric motor. As the shaft rotates, an oscillating vibration is created in the motor, electric-vibrator housing, and other elements with which the motor is coupled. FIGS. 1A-B illustrate a commonly available battery-operated electric vibrator that uses a weight eccentrically mounted to the shaft of a rotary electric motor. FIG. 1A illustrates the electric vibrator, which includes a motor enclosed within a housing 102 that rotates a cylindrical shaft 104 onto which a weight 106 is asymmetrically mounted. FIG. 1B provides a view of the vibrator shown in FIG. 1A looking down from the weight end of the shaft 104 in the direction of the axis of the shaft. As shown in FIG. 1B, the weight 106 is mounted off-center with respect to the axis of the cylindrical shaft 104. The term “cylindrical” refers to a shape with a regular cross section in two dimensions associated with two axes with respect to a third dimension or axis that is not coplanar with the two axes associated with the two dimensions. Traditional cylinders with circular cross sections, cylindrical prisms with polygonal cross sections, cylinders with oval cross sections, and other such cylinders are described by the adjective “cylindrical.”

The types of vibrators shown in FIGS. 1A-B are generally inefficient in operation and prone to failure. The rotary electric motors used in such devices are not generally designed for producing the oscillations that are produced in the cylindrical shaft by the asymmetrically mounted weight. These oscillations tend to rapidly wear and degrade internal parts of the rotary motor, leading to ever increasing inefficiency in operation, loss of vibrational power, and, ultimately, to complete mechanical failure. In addition, the vibrational frequencies generated by such devices are generally limited to a range of 40-110 Hz. Below 40 Hz, the motor generally provides insufficient torque to generate desired vibrational power in the motor and housing. Above 110 Hz, device operation may become unstable and is generally increasingly damped by the motor body and coupled housing as the vibrational frequency increases above 110 Hz. Yet an additional disadvantage of the electric vibrators illustrated in FIGS. 1A-B is that the entire device, including the housing, is generally vibrated as the cylindrical shaft turns, which may lead to user discomfort when the vibrator is held for prolonged periods of time.

FIG. 2 illustrates another type of electric vibrator that is operated from wall power. As shown in FIG. 2, a coil 202 is energized by wall power 204, creating an alternating magnetic field 206 with magnetic field lines generally parallel to the axis of the coil except where they curve into the north and south poles. The alternating magnetic field actuates a spring 210 mounted to a housing 212. Oscillation of the spring 210, indicated by double-headed arrow 214, creates mechanical vibration within the housing 212. Vibrators based on oscillating magnetic fields produced in coils by wall power generally produce greater vibrational power and are generally more reliable than the battery-operated electric vibrators illustrated in FIGS. 1A-B. However, because alternating-current line voltage and residential power supplies provide alternating current at a single frequency, either 50 Hz or 60 Hz, depending on the country in which the residence is located, the coil-based electric vibrators generally produce either only a single frequency of vibration or a relatively narrow range of vibrational frequencies centered about the alternating-current frequency provided by electrical utilities.

FIG. 3 shows a plot of vibrational force with respect to frequency of vibration for the battery-operated electric vibrators illustrated in FIGS. 1A-B and the coil-based electric vibrators illustrated in FIG. 2. In FIG. 3, frequency, in Hz, is plotted with respect to the horizontal axis 302 and force, in units of g, which is a unit of force per unit mass, with one g equivalent to 9.80665 Newtons of force per kilogram of mass, plotted with respect to the vertical axis 304. Cross-hatched region 306 represents the range of vibrational frequencies and forces produced by the coil-based electric vibrators illustrated in FIG. 2 and cross-hatched region 308 represents the range of vibrational frequencies and forces produced by the battery-operated electric vibrators illustrated in FIGS. 1A-B. As can be seen in FIG. 3, the coil-based electric vibrators generally produce greater vibrational force, but over a relatively narrow range of vibrational frequencies while the battery-operated electric vibrators produce less vibrational force over a wider range of vibrational frequencies, from 40 Hz to 100 Hz.

Although manufacturers, vendors, and users of electric vibrators have employed conventional battery-operated and coil-based vibrators for many years, manufacturers, vendors, and users of electric vibrators continue to seek a more robust and reliable vibrating appliance for the various applications mentioned above.

### SUMMARY

The current disclosure is directed to personal vibration appliances, operated either by battery power or wall power, that incorporate a linear-vibration module to generate vibration with frequencies below 40 Hz, between 40 Hz and 110 Hz, and above 110 Hz with forces up to and beyond 15 g. In certain implementations, the frequency and force of vibration may be independently controlled. In certain implementations, the vibrational frequency and/or vibrational power may be correlated to various additional signals, both internal and external, including audio sound signals, light signals, and audiovisual signals. In certain implementations, the vibration appliance features an interchangeable massage piston with interchangeable massage tips and other accessories. Finally, operational characteristics of the personal vibration appliances may be modified by various types of sensor and other feedback signals.

### BRIEF DESCRIPTION OF THE DRAWINGS

FIGS. 1A-B illustrate a commonly available battery-operated electric vibrator that uses a weight eccentrically mounted to the shaft of a rotary electric motor.

FIG. 2 illustrates another type of electric vibrator that is operated from wall power.

FIG. 3 shows a plot of vibrational force with respect to frequency of vibration for the battery-operated electric vibrators illustrated in FIGS. 1A-B and the coil-based electric vibrators illustrated in FIG. 2.

FIGS. 4A-K illustrate the internal components of certain LVM-based personal-vibration-appliance implementations.

FIG. 5 shows one type of LVM-based personal-vibration-appliance implementation.

FIG. 6 provides a plot of the operational characteristics of the PVA shown in FIG. 5 as compared to the operational characteristics of the previously discussed currently available electric vibrators.

FIG. 7 shows the operational characteristics of a specific implementation of an LVM-based PVA.

FIG. 8 illustrates that, by adjusting system parameters, including the strength and weight of the permanent magnet within the linearly oscillating subcomponent of the LVM and the strength of the centering magnet of the LVM, a variety of different types of operational characteristics can be obtained.

FIG. 9 shows, as one example, the two-dimensional region representing the operational characteristics of a LVM-based PVA with a resident frequency of 300 Hz, corresponding to the peak 902 frequency and with a quality factor Q of 2.

FIG. 10 illustrates a transfer function in which a microprocessor-implemented or logic-circuit-implemented control regime decreases the duty cycle within a range a frequencies corresponding to a resonance peak in order to flatten the frequency/power transfer function.

FIG. 11 shows another example of a LVM-based PVA.

FIGS. 12-13 illustrate flux paths incorporated within an LVM in order to increase the efficiency of the LVM in producing linear vibration.

FIG. 14 illustrates an LVM with flux paths and flux discs.

FIGS. 15-16 illustrate, in greater detail, the LVM-based PVA implementation shown in FIG. 5.

FIGS. 17-18 show perspective views of the LVM-based PVA shown previously in FIG. 5.

FIGS. 19-20 illustrate a base component that holds the LVM-based PVA during recharging.

FIG. 21 illustrates the male plug in greater detail.

FIG. 22 provides a flow-control diagram that illustrates audio control of a PVA in one implementation of an audio-control PVA to which the current document is directed.

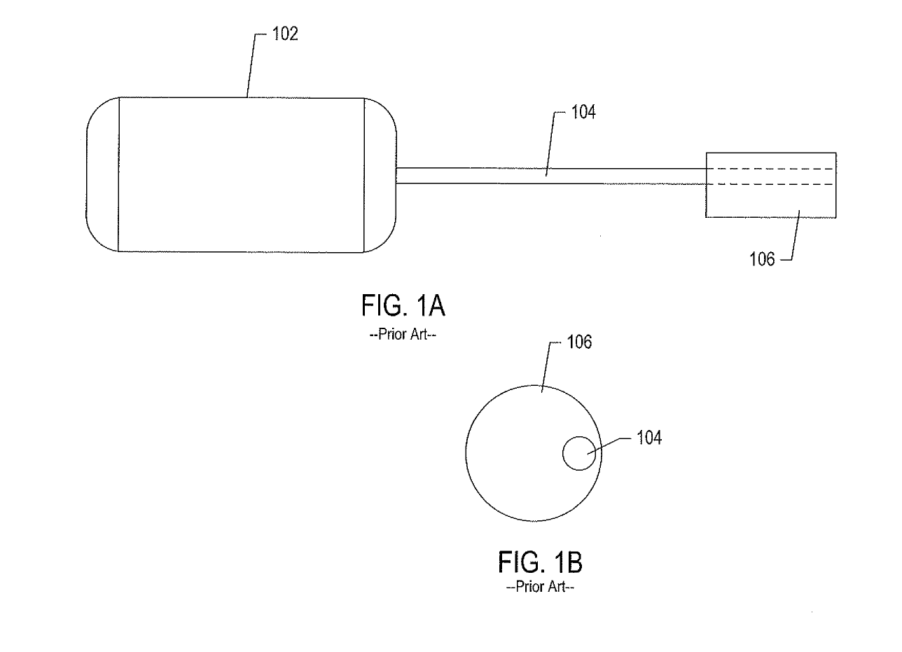

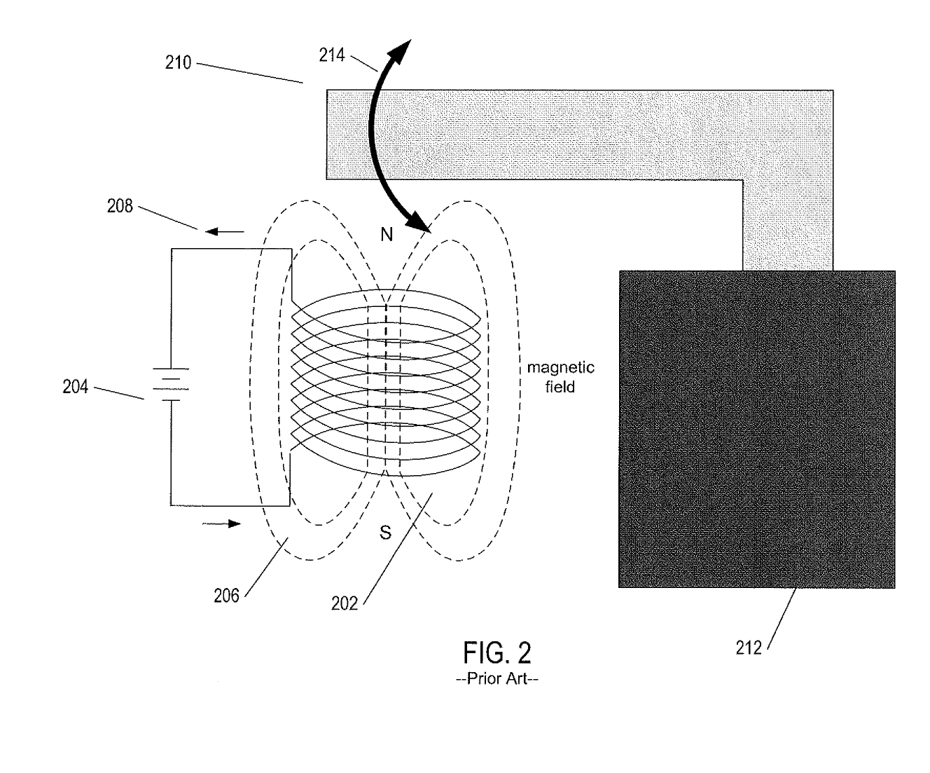

### DETAILED DESCRIPTION

The current document is directed to a variety of different personal vibration appliances based on linear-vibration modules (“LVMs”). Vibrational forces are produced by an LVM as a result of linear oscillation of a weight or moveable subcomponent, in turn produced by alternating the polarity of one or more driving elements. The force and frequency of the vibrations produced by an LVM can be independently controlled over a broad range of vibrational forces and vibrational frequencies. In many implementations, the personal vibration appliance (“PVA”) provides input features, such as buttons, sliders, switches, or other types of input features, that allow a user of the PVA to independently control the force of vibration and the frequency of vibration in order to select particular points, or modes, within the two-dimensional force/frequency space that characterizes operation of an LVM-based PVA. In other implementations, a user may select from among numerous predetermined vibrational modes.

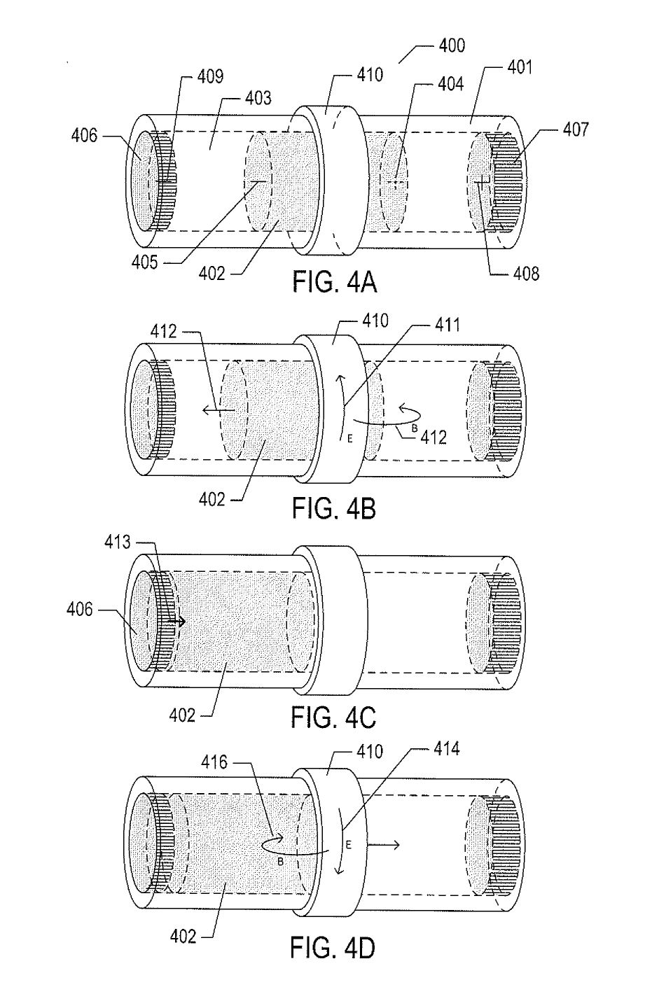

FIGS. 4A-K illustrate the internal components of certain LVM-based personal-vibration-appliance implementations. FIGS. 4A-G illustrate one type of LVM, and all of FIGS. 4A-G use the same illustration conventions, next discussed with reference to FIG. 4A. The LVM includes a cylindrical housing 401 within which a solid, cylindrical mass 402, or weight, can move linearly along the inner, hollow, cylindrically shaped chamber 403 within the cylindrical housing or tube 401. The weight is a magnet, in this implementation, with polarity indicated by the “+” sign 404 on the right-hand end and the “−” sign 405 on the left-hand end of the weight 402. The cylindrical chamber 403 is capped by two magnetic disks 406 and 407 with polarities indicated by the “+” sign 408 and the “−” sign 409. The disk-like magnets 406 and 407 are magnetically oriented opposite from the magnetic orientation of the weight 402, so that when the weight moves to either the extreme left or extreme right sides of the cylindrical chamber, the weight is repelled by one of the disk-like magnets at the left or right ends of the cylindrical chamber. In other words, the disk-like magnets act much like springs, to facilitate deceleration and reversal of direction of motion of the weight and to minimize or prevent mechanical-impact forces of the weight and the end caps that close off the cylindrical chamber. Finally, a coil of conductive wire 410 girdles the cylindrical housing, or tube 401, at approximately the mid-point of the cylindrical housing.

FIGS. 4B-G illustrate operation of the LVM shown in FIG. 4A. When an electric current is applied to the coil 410 in a first direction 411, a corresponding magnetic force 412 is generated in a direction parallel to the axis of the cylindrical chamber, which accelerates the weight 402 in the direction of the magnetic force 412. When the weight reaches a point at or close to the corresponding disk-like magnet 406, as shown in FIG. 4C, a magnetic force due to the repulsion of the disk-like magnet 406 and the weight 402, 413, is generated in the opposite direction, decelerating the weight and reversing its direction. As the weight reverses direction, as shown in FIG. 4D, current is applied in an opposite direction 414 to the coil 410, producing a magnetic force 416 in an opposite direction from the direction of the magnetic force shown in FIG. 4B, which accelerates the weight 402 in a direction opposite to the direction in which the weight is accelerated in FIG. 4B. As shown in FIG. 4E, the weight then moves rightward until, as shown in FIG. 4F, the weight is decelerated, stopped, and then accelerated in the opposite direction by repulsion of the disk-like magnet 407. An electrical current is then applied to the coil 410 in the same direction 416 as in FIG. 4B, as shown in FIG. 4G, again accelerating the solid cylindrical mass in the same direction as in FIG. 4B. Thus, by a combination of a magnetic field with rapidly reversing polarity, generated by alternating the direction of current applied to the coil, and by the repulsive forces between the weight magnet and the disk-like magnets at each end of the hollow, cylindrical chamber, the weight linearly oscillates back and forth within the cylindrical housing 401, imparting a direction force at the ends of the cylindrical chamber with each reversal in direction. Disk-like magnets 406-407 represent one example of a centering component that centers the weight within the LVM.

The amplitude of the vibration and vibrational forces produced by LVM are related to the length of the hollow chamber in which the weight oscillates, the current applied to the coil, the mass of the weight, the acceleration of the weight produced by the coil, and the mass of the entire LVM. All of these parameters are essentially design parameters for the LVM, and thus the LVM can be designed to produce a wide variety of different vibrational amplitudes and frequencies. As discussed below, there are many additional types of LVMs.

FIG. 4H illustrates internal components of a generalized LVM-based PVA in a block-diagram presentation. The PVA comprises an outer housing 418 within which a movable subcomponent or weight 419 linearly oscillates with respect to an inner housing 420. The inner housing and moveable subcomponent together comprise the LVM. A power supply 421 provides power, to a control component 423 and a drive component 424 which cooperate to drive the movable subcomponent 419 to linearly oscillate relative to the inner housing 406. Solid arrows, such as solid arrow 422, represent electronic connections, or other type of communications and control connections, between the inner components and subcomponents of the LVM-based PVA. Dotted arrows, such as dotted arrow 425, represent linear motion of the movable subcomponent with respect to the inner housing.

FIGS. 4I-J illustrate an H-bridge switch that can be used, in various implementations, to change the direction of current applied to the coil that drives linear oscillation within an LVM of the type shown in FIGS. 4A-G as well as within additional types of LVMs. FIGS. 4I-J both use the same illustration conventions, described next with respect to FIG. 4I. The H-bridge switch receives, as input, a directional signal d 426 and direct-current (“DC”) power 427. The direction-control signal d 426 controls four switches 428-431, shown as transistors in FIG. 4I. When the input control signal d 426 is high, or “1,” as shown in FIG. 4I, switches 430 and 431 are closed and switches 429 and 428 are open, and therefore current flows, as indicated by curved arrows, such as curved arrow 432, from the power-source input 427 to ground 433 in a leftward direction through the coil 434. When the input-control signal d is low, or “0,” as shown in FIG. 4J, the direction of the current through the coil is reversed. The H-bridge switch, shown in FIGS. 4I-J, is but one example of various different types of electrical and electromechanical switches that can be used to rapidly alternate the direction of current within the coil or coils of various types of LVMs.

FIG. 4K provides a block diagram of one type of LVM-based PVA. The PVA includes a power supply 448, a user interface 440, generally comprising electromechanical buttons or switches, the H-bridge switch 456, discussed above with reference to FIGS. 4I-J, a central processing unit (“CPU”) 436, generally a small, low-powered microprocessor, and one or more electromechanical sensors 466.

As shown in FIG. 4K, the LVM 456, 462, and 468 is controlled by a control program executed by the CPU microprocessor 436. The microprocessor may contain sufficient on-board memory to store the control program and other values needed during execution of the control program, or, alternatively, may be coupled to a low-powered memory chip 438 or flash memory for storing the control program. The CPU receives inputs from the user controls 440 that together comprise a user interface. These controls may include any of various dials, pushbuttons, switches, or other electromechanical-control devices. As one example, the user controls may include a dial to select a strength of vibration, which corresponds to the current applied to the coil, a switch to select one of various different operational modes, and a power button. The user controls generate signals 442, 444, 446 input to CPU 436. The power supply 448 provides power, as needed, to user controls 440, to the CPU 436 and optional, associated memory 438, to the H-bridge switch 456, and, when needed, to one or more sensors 466. The voltage and current supplied by the power supply to the various components may vary, depending on the operational characteristics and requirements of the components. The H-bridge switch 456 receives a control-signal input d 458 from the CPU. The power supply 448 receives a control input 460 from the CPU to control the current supplied to the H-bridge switch 454 for transfer to the coil 462, and the power supply may provide a signal 452 to the CPU. The CPU receives input 464 from one or more electromechanical sensors 466 that generate a signal corresponding to the strength of vibration currently being produced by the linearly oscillating mass 468. Sensors may include one or more of accelerometers, piezoelectric devices, pressure-sensing devices, or other types of sensors that can generate signals corresponding to the strength of desired vibrational forces.

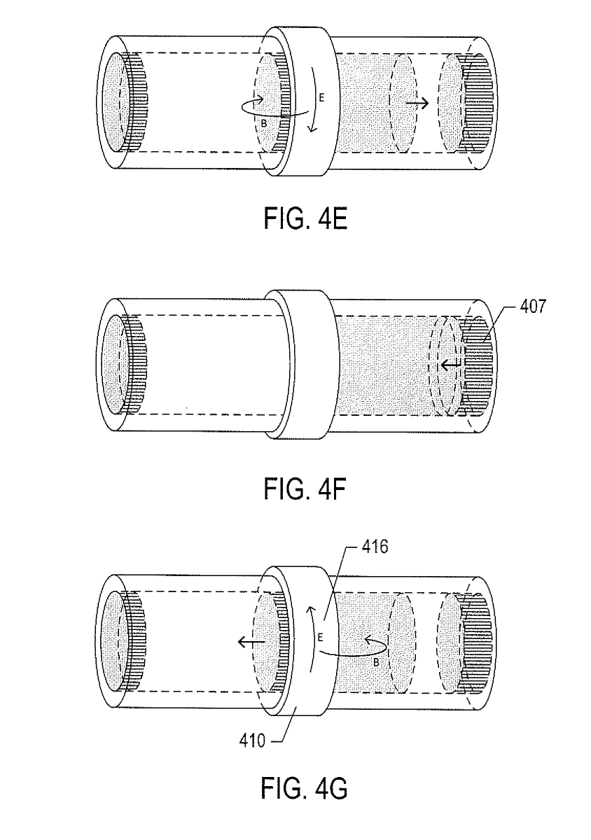

FIG. 5 shows one type of LVM-based personal-vibration-appliance implementation. The outer housing 502 has a rounded shape. A rounded tip of an piston 504 protrudes through an opening at the bottom of the device, as depicted in FIG. 5. The piston is the moveable subcomponent of an LVM within the PVA. Buttons 506-508 provide a user interface that allows a user to select various vibration modes by varying various parameter values that control operation of the LVM. A funnel-like aperture 510 leads to an internal channel, not shown in FIG. 5, in addition to the opening through which the rounded tip of the piston protrudes. The piston linearly oscillates within the cylindrical inner channel. The PVA implementation shown in FIG. 5 can be controlled to produce vibrational frequencies ranging from 10 Hz to greater than 350 Hz. The PVA shown in FIG. 5 is compact, designed to be comfortably held for a variety of applications, and, as discussed further below, features, in many implementations, removable and interchangeable pistons and piston tips.

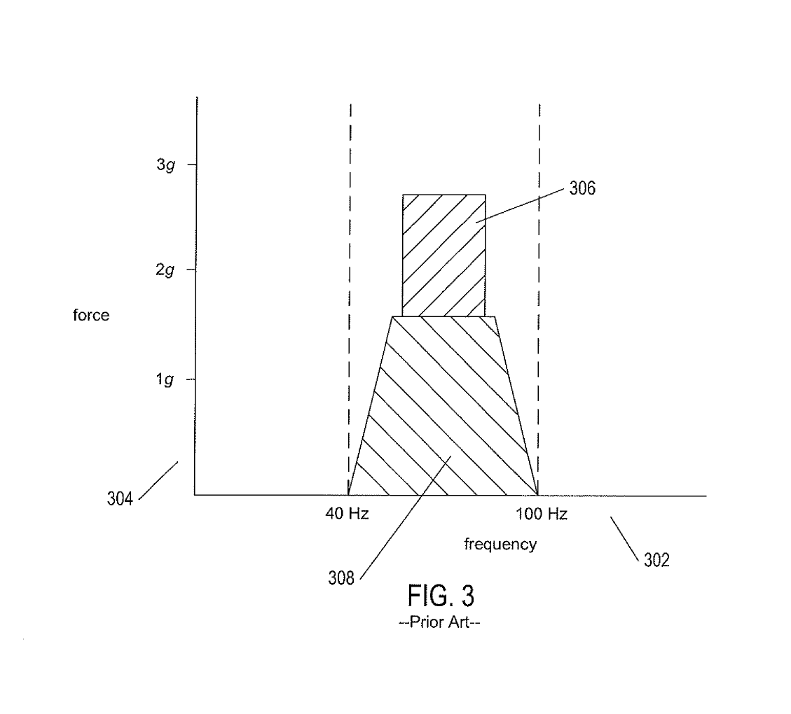

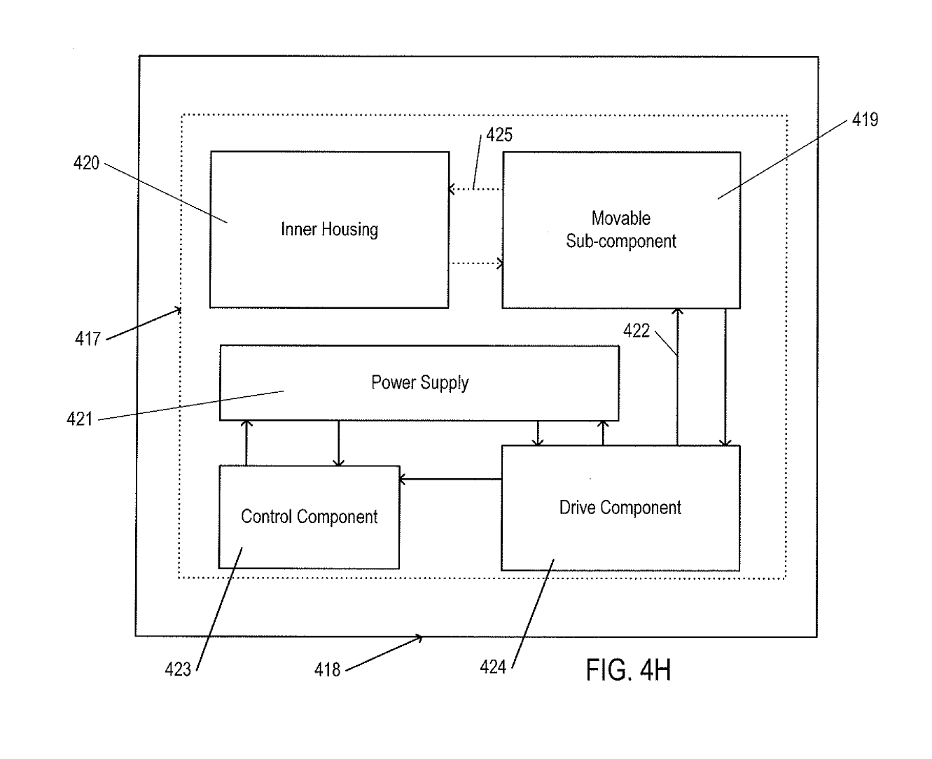

FIG. 6 provides a plot of the operational characteristics of the PVA shown in FIG. 5 as compared to the operational characteristics of the previously discussed currently available electric vibrators. FIG. 6 uses the same illustration conventions previously used in FIG. 3. The horizontal axis 602 represents frequency and the vertical axis 604 represents vibrational force. The two-dimensional operational range 606 of the PVA shown in FIG. 5 can be seen, in FIG. 6, to be both broader and taller than the operational ranges of the coil-based electric vibrator 608 and the battery-operated electric vibrator 610. The PVA shown in FIG. 5 can achieve higher vibrational forces than either of the currently available electric vibrators and provides a much broader range of vibrational frequencies than either of the two previously described currently available electric vibrators. Points within the two-dimensional operation range correspond to different vibrational modes or regimes. Different vibrational modes or regimes can be scheduled in various sequences to provide higher-level, composite vibrational regimes. Because the LVM-based PVA shown in FIG. 5 has a large operational range 606, this LVM-based PVA represents a geometrical increase in the number of different vibrational modes or regimes and composite vibrational regimes that can be produced by the LVM-based PVA with respect to the currently available electric vibrators discussed above.

The PVA shown in FIG. 5 has additional benefits with respect to the previously described, currently available electric vibrators. In the PVA shown in FIG. 5, the vibration is highly directional due to linear oscillation of the piston within an inner channel. As a result, the vibrational forces, already significantly greater than those achievable by either of the currently available types of electric vibrators, are concentrated directionally to impart even greater forces to a user's body within an area against which the piston tip impacts. In the currently available, battery-operated electric vibrators, vibration is imparted to the entire housing of the device, only a small portion of which is then transferred to a patient's body via a relatively small percentage of the area of the housing that contacts the patient's body. By contrast, in the device shown in FIG. 5, the linear oscillating subcomponent, or piston, protrudes outward from the housing and directly impacts the surface of a user's body.

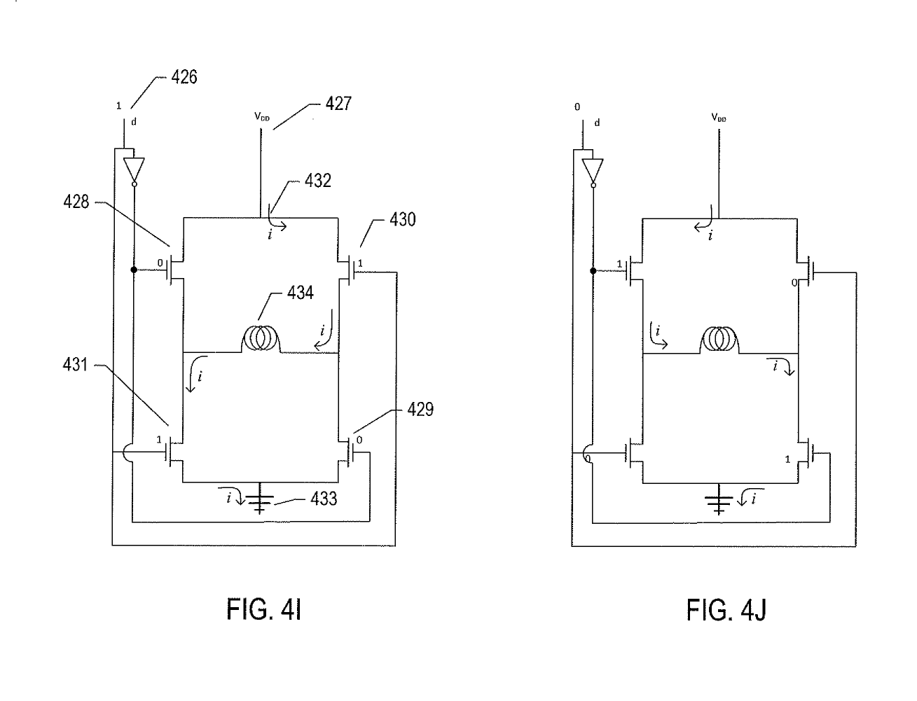

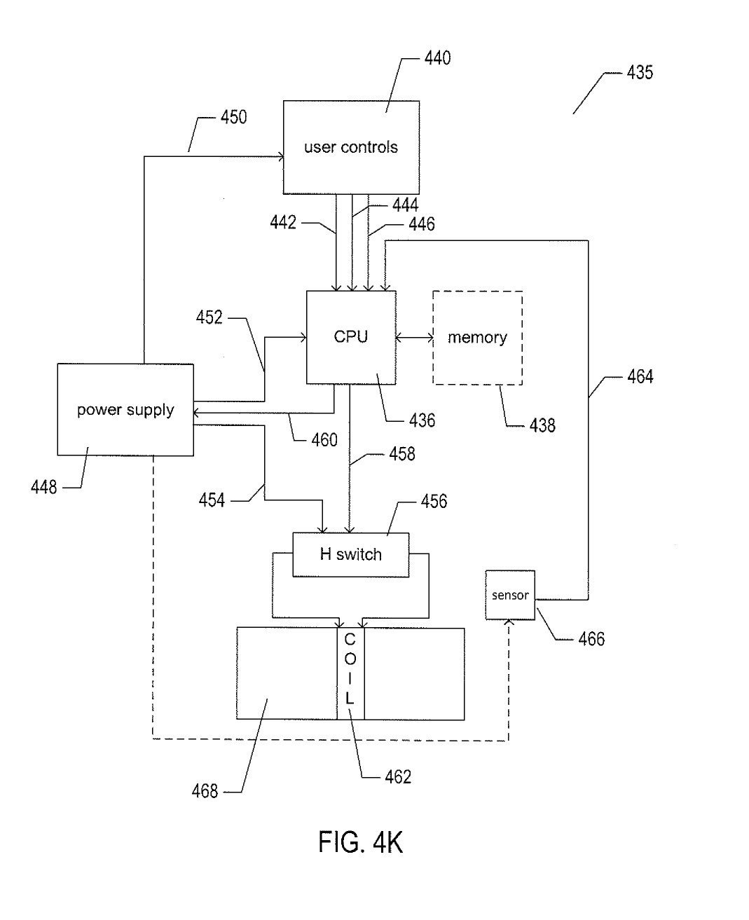

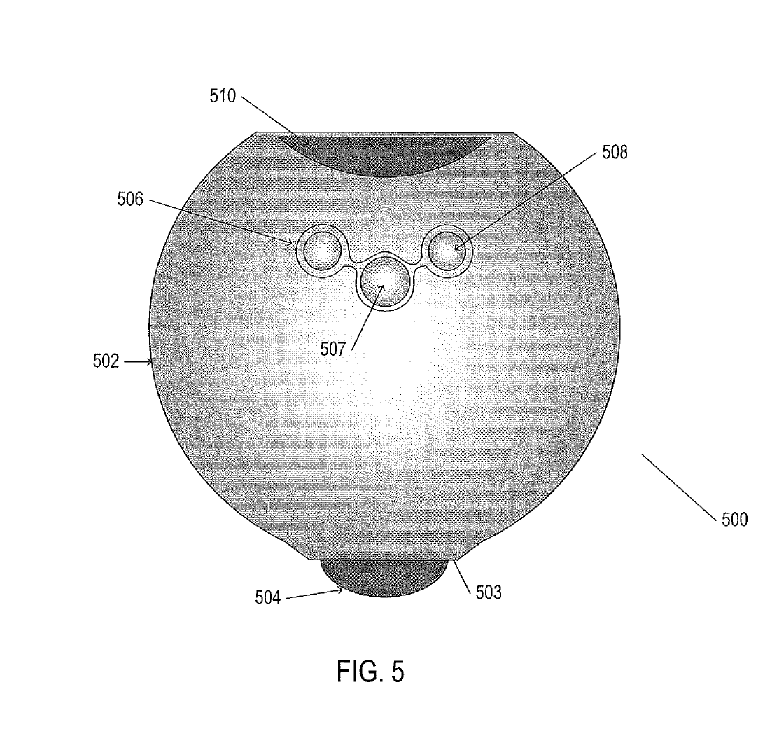

FIG. 7 shows the operational characteristics of a specific implementation of an LVM-based PVA. As with the previously described plots, the horizontal axis 702 represents frequency and the vertical axis 704 represents vibrational force, in this case in units of Newtons or other such units of force. Using the same illustration conventions, FIG. 8 illustrates that, by adjusting system parameters, including the strength and weight of a permanent magnet within the linearly oscillating subcomponent of the LVM and the strength of a centering magnet of the LVM, a variety of different types of operational characteristics can be obtained. In FIG. 8, the four different two-dimensional regions corresponding to the operational characteristics of the LVM-based PVA bounded from above by curves 802-805 represent four different sets of operational characteristics obtained from combinations of two different spring-constant values for the centering magnet and two different masses of the linearly oscillating subcomponent of the LVM. LVM-based PVAs can be designed to have specific, relatively small two-dimensional operational regions but may also be designed to achieve two-dimensional operational regions with very large areas in order to produce a wide range of vibrational modes and regimes for selection by users. FIG. 9 shows, as one example, the two-dimensional region representing the operational characteristics of a LVM-based PVA with a resonant frequency of 300 Hz, corresponding to the peak 902 frequency and with a quality factor Q of 2.

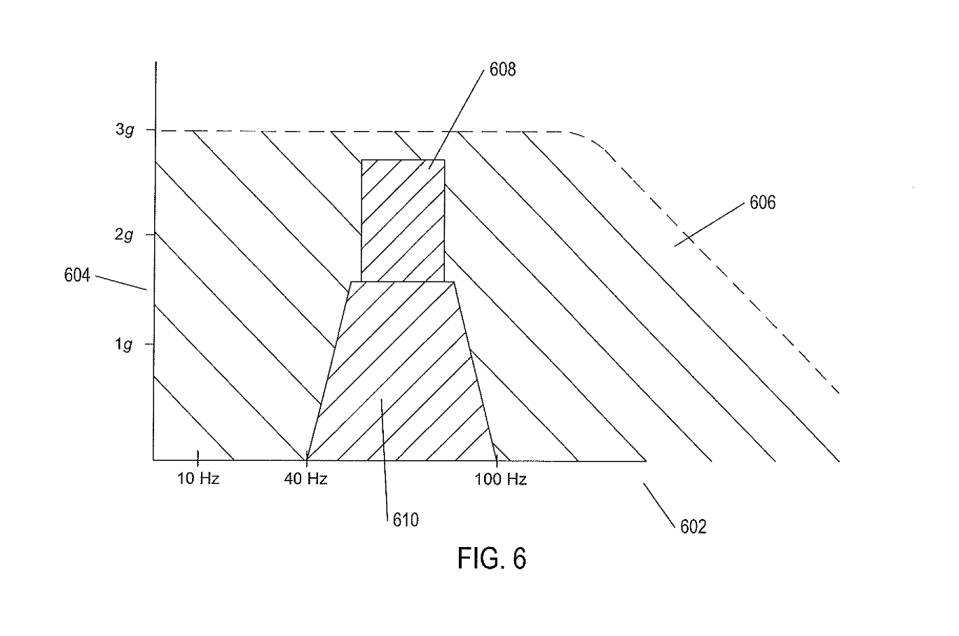

The plots of operational characteristics provided in FIGS. 7-9, also referred to as plots of “transfer functions,” refer to operational characteristics of LVMs independent of the types of control operations that may be applied to an LVM by a microprocessor control unit or various types of control circuitry. Microprocessor or logic-circuitry-implemented control regimes may alter the shape of frequency/power transfer functions. As one example, the duty cycle of frequencies in a particular frequency range can be decreased to 50 percent but maintained at 100 percent for vibrational frequencies outside this range. This provides a control strategy that smoothes or knocks down the prominent resonant-frequency peak of a transfer function. FIG. 10 illustrates a transfer function in which a microprocessor-implemented or logic-circuit-implemented control regime decreases the duty cycle within a range a frequencies corresponding to a resonance peak in order to flatten the frequency/power transfer function. In FIG. 10, curve 1002 represents the native transfer function for an LVM module and curve 1004 represents a transfer function modified by microprocessor-implemented or logic-circuit-implemented control. Microprocessor-implemented or logic-circuit-implemented control can also be used to obtain relatively constant power output across a wide range of vibrational frequencies. These control regimes employ duty-cycle adjustments, variation of the voltage output from the power supply, changes of bias voltages on switching electronic components, and by many other such control strategies. Microprocessor-based or logic-circuitry-based control can be used to generate two-dimensional power/frequency operational spaces of arbitrary area and shape.

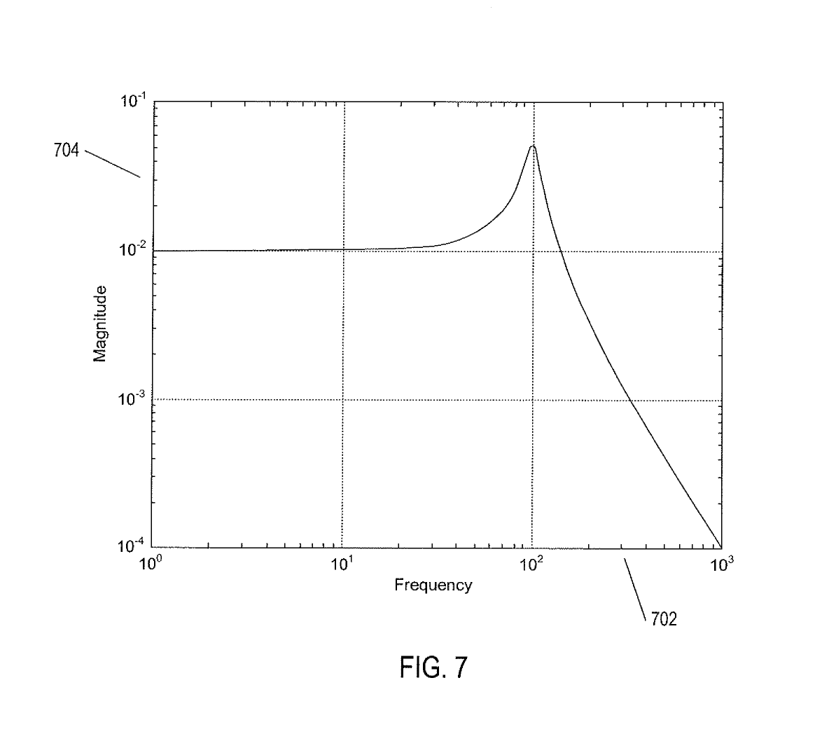

FIG. 11 shows another example of a LVM-based PVA. In FIG. 11, a piston 1102 is positioned within a channel 1104 within the main housing 1106 of a LVM-based PVA. The PVA additionally includes a power supply 1108, a microcontroller 1110, and switching electronics 1112. The microcontroller 1110 may be used in certain implementations and may be omitted in other implementations.

At rest, the piston 1102 is held in a centered position by a centering magnet 1116 which centers and aligns the driving magnet 1114 incorporated within the piston. Note that the piston channel 1104 and piston 1102 are cylindrical, as is the centering magnet 1116. The centering magnet is another example of a centering component. There centering magnet may be cylindrical or may have other shapes, and two or more centering magnets may be used in alternative implementations. Current is applied either to a first driving coil 1118 or to a second driving coil 1120, both cylindrically wound around the outside of the piston channel, in order to drive the piston upward or downward, respectively. By rapidly switching the application of current to the driving coils, or rapidly changing the direction of the applied current to both driving coils using switching electronics, the piston is controlled to linearly oscillate up and down within channel 1104, as indicated by double-headed arrow 1122.

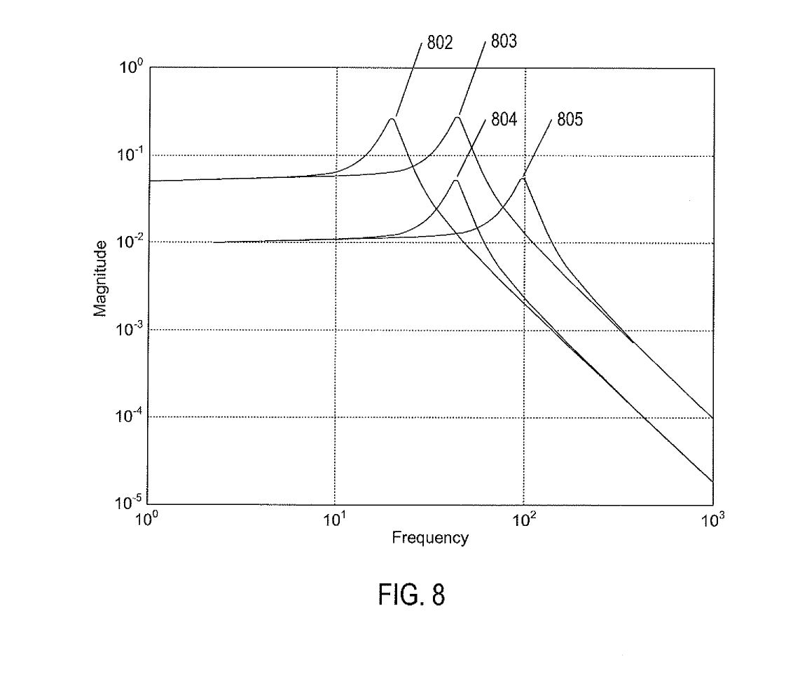

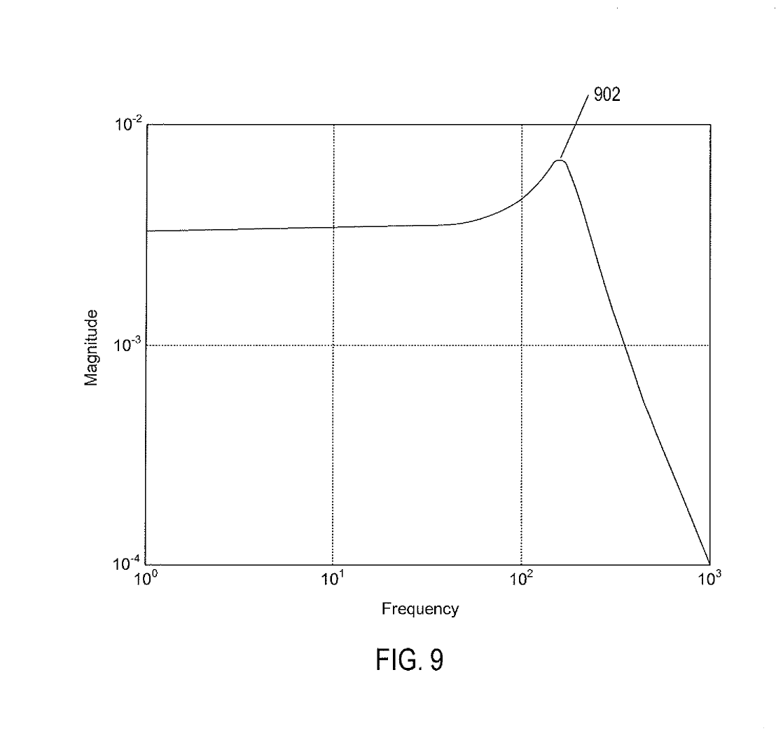

FIGS. 12-13 illustrate flux paths incorporated within an LVM in order to increase the efficiency of the LVM in producing linear vibration. In free air, magnetic field lines radiate outwards in arcs from the north pole to the south pole to complete a magnetic circuit. Free air is analogous to a resistor in an electronic circuit and increases the magnetic reluctance of a magnetic circuit, reducing the magnitude of the flux of the magnetic field. In general, a magnetic field seeks out the path of least magnetic reluctance in order to maximize the magnitude of the magnetic flux between the two poles. Paramagnetic materials generally provide a lower-reluctance path for magnetic field lines when they have adequate permeability and size to avoid saturation. The LVM shown in FIG. 12 includes a piston 1202 with a driving magnet 1204 that is driven to oscillate by alternating current supplied to the cylindrical coils 1206 and 1208 with respect to centering magnet 1210. The piston moves upward and downward within a cylindrical channel 1212. This LVM lacks designed flux paths, as a result of which the magnetic field lines 1214 and 1216 flow through free air. By contrast, the LVM shown in FIG. 13 includes flux paths 1316 and flux discs 1318 and 1320 on either side of the driving magnet within the piston to direct the magnetic field lines through flux paths 1316 and flux discs 1318 and 1320, as a consequence of which only relatively small portions of the magnetic field lines traverse free air. Thus, the magnetic reluctance is significantly decreased in the LVM with flux paths, shown in FIG. 13, resulting in a more efficient LVM.

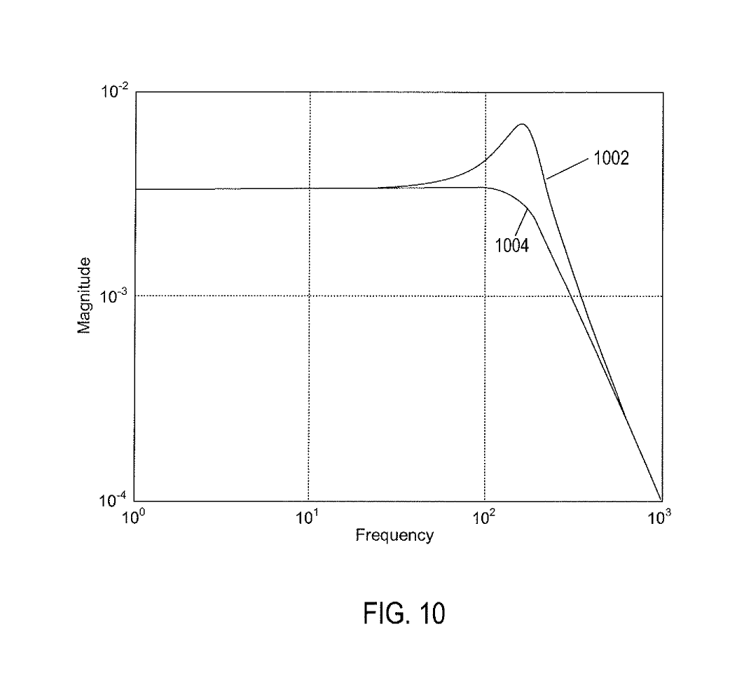

FIG. 14 illustrates an LVM with flux paths and flux discs. The LVM includes a cylindrical piston 1402 within a cylindrical piston channel 1404, driving magnet 1406, cylindrical centering magnet 1418, cylindrical coils 1414 and 1416, and flux discs 1420 and 1422. An additional benefit of the flux paths is that they act as a kind of magnetic stop for the linear-oscillation motor. During operation, the driving magnet 1406 oscillates about the fixed mid plane of the centering magnet 1418. When a resisting normal force is encountered at the end of the piston, during use of the PVA, the driving magnet is biased downward and oscillates about a datum offset from the fixed mid plane of the centering magnet. When the resisting force is greater than the electromagnetic force generated by the motor, the piston assembly is driven further into the piston channel until flux disc 1422 is in line with the return loop 1424 of the flux path 1426. In this position, the distance traversed by magnetic field lines within air is minimal and maximum magnetic flux is obtained in a radial direction between the flux disc and flux path. Additional force is needed to move the piston beyond this point of maximum flux, effectively producing a magnetic stop. This magnetic-stop effect also prevents the piston from being ejected from the piston channel at high power and low-frequency settings in which the piston has significant momentum.

As discussed above, LVM-based PVAs generate much larger linearly directed forces than currently available wall-powered and battery-powered electric vibrators. This is particularly true of the battery-operated electric vibrators. LVMs generate highly directional vibrational forces compared to imbalanced rotary direct-current motors and can be operated at higher powers than would be possible for imbalanced-rotary DC motors that are prone to component failure due to the non-rotational forces generated from the asymmetrically mounted weight on the spinning motor shaft. As discussed above, battery-powered electric vibrators that utilize imbalanced DC motors generally created vibrational forces of less than 5 g, and most generate vibrational forces less than 3 g. By contrast, an LVM-based PVA may generate linearly directed forces between 2 g and 15 g.

As discussed above, the inclusion of a microcontroller within a LVM-based PVA allows for more complex control regimes in order to adjust the amplitude, frequency, and wave shape of signals applied to the drive components of the LVM, thereby selecting particular vibrational forces, frequencies, and wave shapes within broad ranges of operational characteristics of the LVM-based PVA. The microcontroller, in these case, executes instructions reinstalled as firmware within either the microcontroller memory or an external memory, software downloaded to the LVM-based PVA, user-defined programs downloaded to the LVM-based PVA or generated within the LVM-based PVA in response to user input, and from other sources. However, it is also possible to use various logic circuitry in addition to, or rather than, a microprocessor for controlling the driving components of an LVM-based PVA. Instructions and control inputs can be delivered to a microcontroller-equipped LVM-based PVA via user input, Bluetooth, ZigBee, WiFi, or other types of wireless interfaces.

A control program may generate control signals to driving components that are modulated or determined by various internally generated or external signals, including audio signals, multi-media signals, and other such types of input signals. This allows the LVM-based PVA to produce vibrational patterns that reproduce or vary along with the various types of external or internally generated input signals, including music. The input signals may be computationally generated, within the LVM-based PVA, from stored electronic data and can alternatively be obtained by the LVM-based PVA using microphones, wirelessly downloaded electronic data, electronic data input to the LVM-based PVA through a universal serial bus (“USB”), serial port, or other type of wired connection.

The power supply for an LVM-based PVA can use various types of chemical batteries, including rechargeable batteries, as well as rectified wall power in various different implementations. In certain implementations, rechargeable lithium-ion polymer batteries are used to increase portability and maximize energy-storage density.

As discussed with reference to FIG. 5, in certain implementations, the linearly oscillating subcomponent is a cylindrical massage piston with a tip that protrudes from the outer housing of the PVA. This design allows a user to grasp and hold the outer housing in order to apply vibrational forces from the piston tip directly against the skin surface. For massage applications, the tip may be fashioned from relatively soft materials, including silicone, rubber, thermoplastic elastomer polymers, and other such materials. The massage piston may have removable tips, the removable tips having various forms, shapes, and compositions and comprising various different types of PVA accessories, including brushes, soft massaging tips, and harder massaging tips. Alternatively, the massage piston may be attached internally to a diaphragm made from rubber, silicone, or some other compliant material connected to the housing, so that the PVA surface is unbroken, without an aperture through which the piston extends, while nonetheless allowing the piston to apply force relatively directly to a user's body.

In the implementation shown in FIG. 5, the piston is held within the PVA by magnetic attraction between the centering magnet that girdles the piston channel and the driving magnet incorporated within the piston. These magnetic forces can be mechanically overcome by a user in order to remove the piston, the mechanical forces potentially facilitated by active control to move the piston upward, away from the centering magnet. Thus, not only the piston tips, but the piston itself may be removable and interchangeable. For example, different pistons may have different weights and different strengths of the driving magnets and will allow the PVA to have a variety of different operational characteristics as represented by the transfer functions. Certain pistons may include internal springs, fluids, or moving subcomponents that could significantly alter the operational characteristics of the PVA. The control program for a PVA may use any of various types of sensor input to detect when there is no piston mounted within the channel and disable PVA operation until a piston has been mounted within the channel of the PVA.

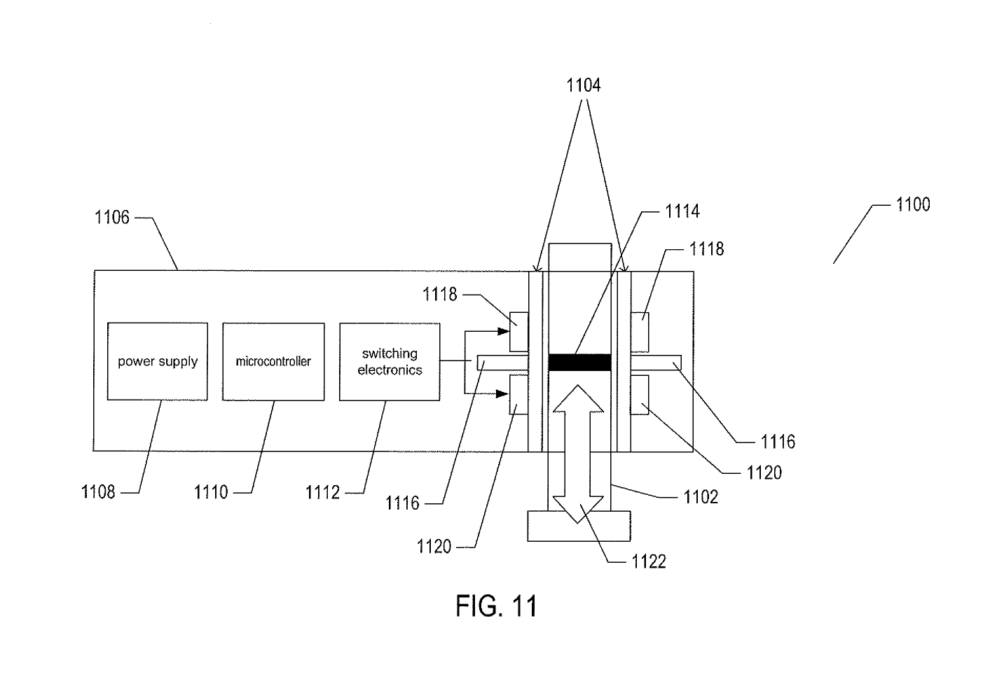

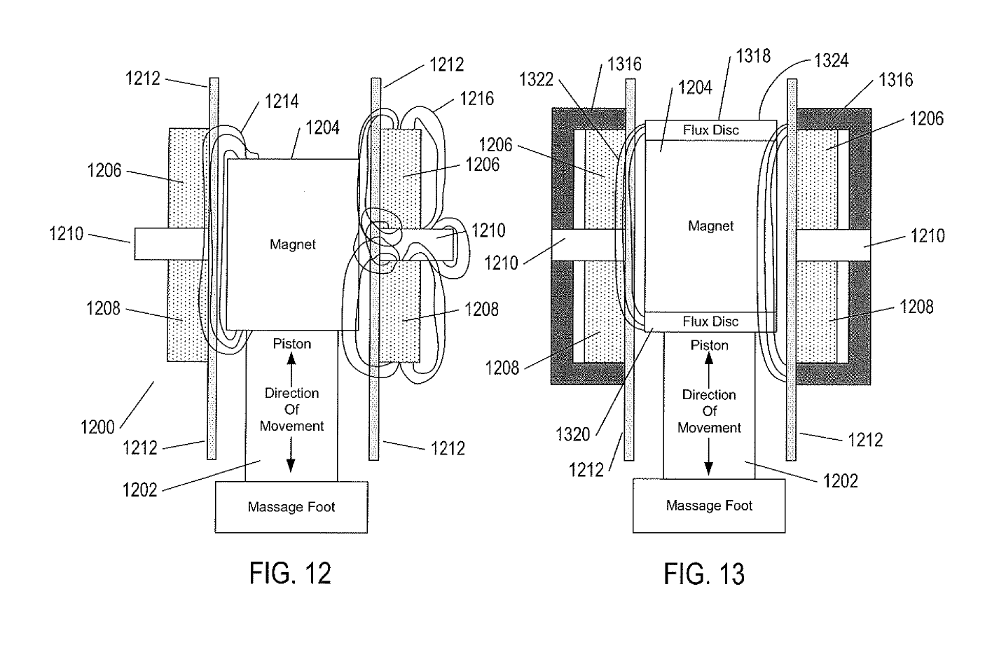

FIGS. 15-16 illustrate, in greater detail, the LVM-based PVA implementation shown in FIG. 5. FIG. 15 shows the inner housing that contains the cylindrical piston channel. The inner housing, in this implementation, is essentially a plastic bobbin 1500. The piston may be manufactured by an injection-molding process and drafted from the mid plane 1502 of the bore outwards by 0.25 to 0.5 degrees per side. In one implementation, this piston has a diameter of between 0.635 inches and 0.665 inches and the cylindrical piston channel within the bobbin has an inner diameter of 0.64 inches to 0.67 inches, respectively, in order to produce a 0.005 inch gap between the walls of the piston channel and the piston in order to accommodate the variations or tolerances inherent in the injection molding process. An ideal gap is between 0.003 inches and 0.008 inches, but can be as large as 0.015 inches without deleteriously impacting the operational characteristics of the LVM. One of the two coils 1504 is shown wound around the outer right side of the bobbin. In many implementations, the coil is a copper winding and is counter-wound. In many implementations, the coils are wound to 180-200 amp turns to achieve a desired balance between motor size and power. The bobbin-like inner housing additionally forms flux paths to lower the magnetic reluctance of the LVM that comprises the bobbin-like inner housing and piston.

FIG. 16 shows the LVM-based PVA of FIG. 5 in cross section. The bobbin-like inner housing 1602 and piston 1604 can be seen to be radially disposed along an axis of symmetry passing through the center of the PVA. The driving magnet 1608 is inserted within the piston. In certain implementations, the magnet has a strength of 5900+/−200 Gauss and is a grade N42 neodymium-iron-boron rare earth magnet. The polarity of the driving magnet is generally opposite that of the centering magnet. Piston 1604 has a relatively wide tip 1605 that protrudes from the outer housing 1606. The diameter of this tip is considerably wider than the diameter of the piston channel 1610. Because the tip protrudes from the piston channel, the size of the tip is not constrained by the diameter of the piston channel. In certain implementations, the tip has a diameter of 0.7 to 0.8 inches, but may have diameters outside this range for particular applications. In one implementation, the maximum linear excursion of the tip along the piston-channel axis is 0.375 inches.

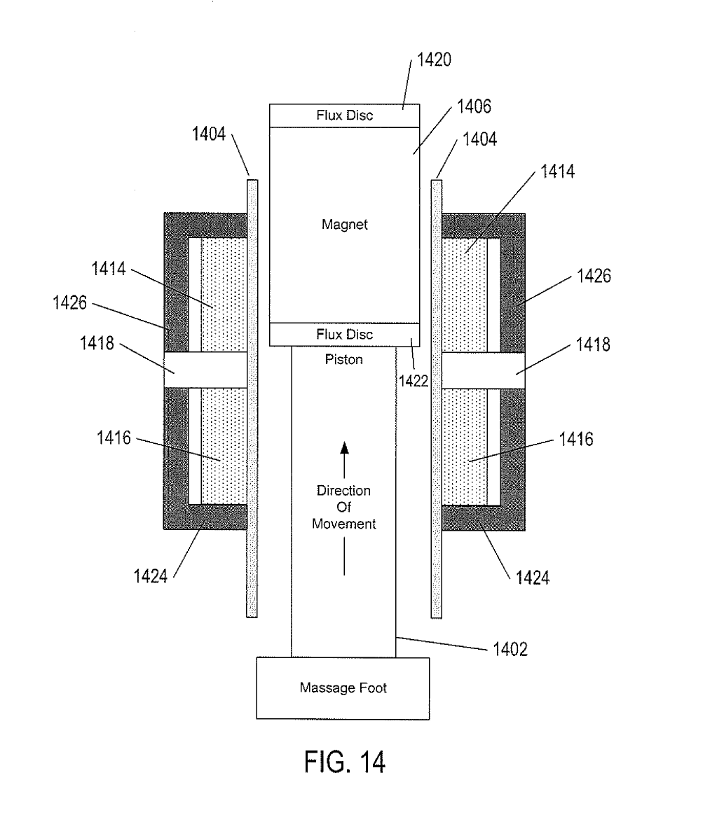

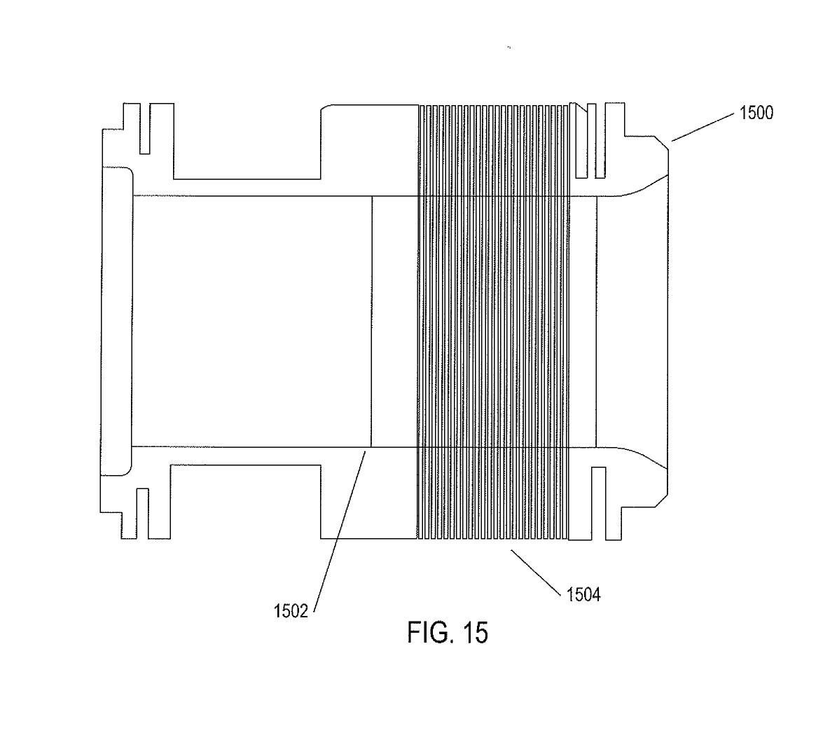

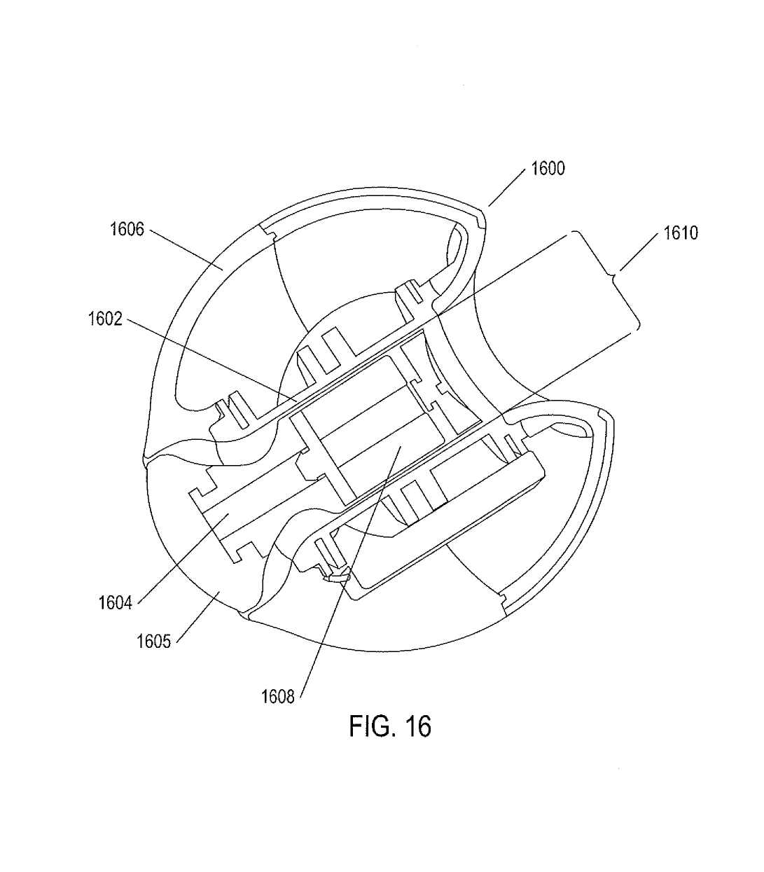

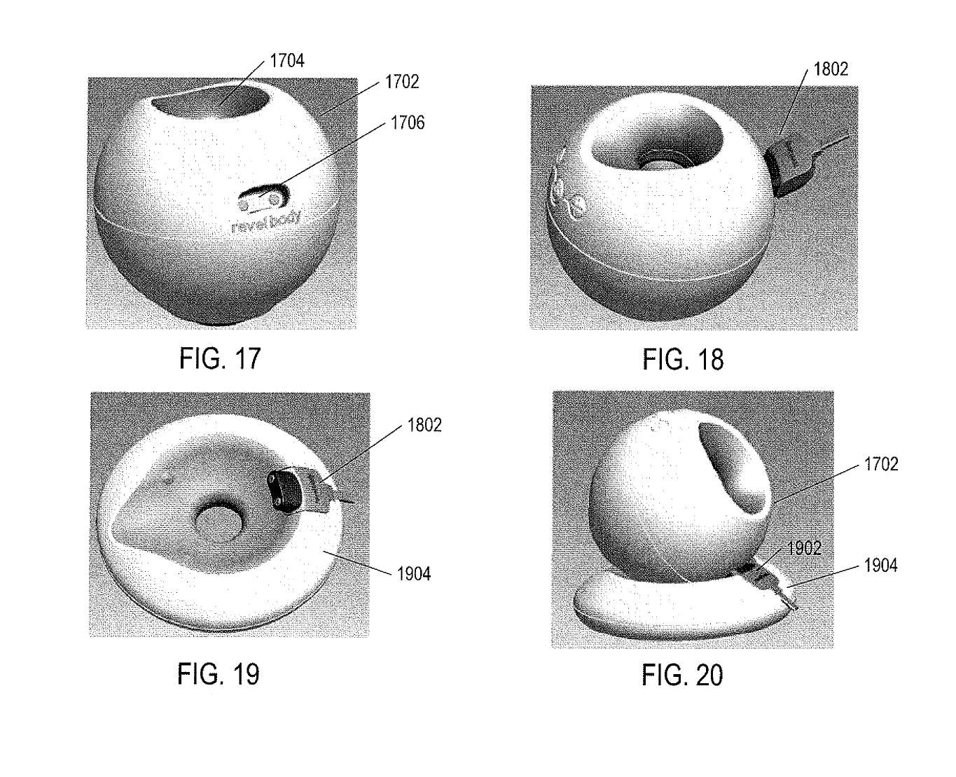

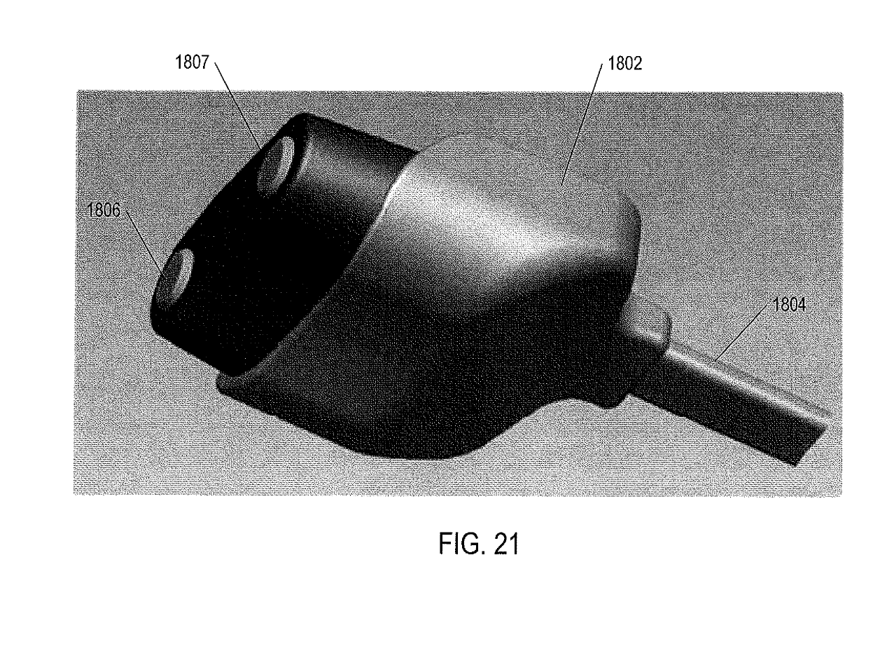

As discussed above, the outer housing of the LVM-based PVA can be constructed to have a variety of different form factors. FIGS. 17-18 show perspective views of the LVM-based PVA shown previously in FIG. 5. The LVM-based PVA 1702 includes the funnel-shaped aperture 1704 previously discussed with reference to FIG. 5. In certain implementations, this funnel-shaped aperture or cavity can be covered by a compliant or flexible external surface or diaphragm, the movement of which provides an alternating suction/compression effect due to air vibrating within the piston channel and cavity. This provides a second, different type of vibrational force in addition to the piston-tip-based vibrational force previously described. The housing of the LVM-based PVA additionally contains a recessed power-connector port 1706 into which a male power plug is inserted in order to connect a rechargeable battery within the LVM-based PVA to external power for recharging. In the implementation shown in FIGS. 17-18, this power port is a port that magnetically mates the male plug to the complementary power-connector port 1706. In alternative implementations, the plug may be mated to the power-connector port by various other types of mechanical or electromagnetic means, such as press-fit and snap-fit adapters. FIGS. 19-20 illustrate a base component that holds the LVM-based PVA during recharging. The base component 1904 includes a feature into which the male plug 1802 can be mounted. Then, when the LVM-based PVA 1702 is placed onto the base component 1904, the male plug is inserted into, and mates with, the power-connector port. FIG. 21 illustrates the male plug in greater detail. The male plug includes a rigid member 1802 into which a cord 1804 is mounted and two disc-like, magnetic electrical connectors 1806 and 1807.

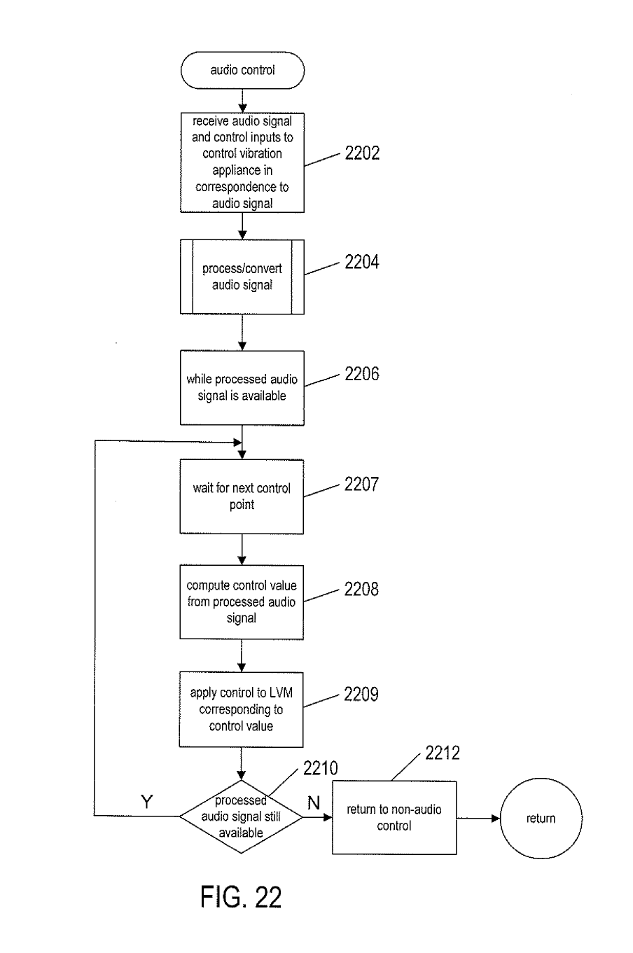

As discussed above, certain implementations of LVM-based PVAs can be controlled by audio signals, including music signals. FIG. 22 provides a flow-control diagram that illustrates audio control of a PVA in one implementation of an audio-control PVA to which the current document is directed. In step 2202, an analog audio signal is received along with control inputs that indicate that the vibration modes of the PVA are to be subsequently controlled in correspondence with the audio signal. A variety of different control features and user input based on these control features can be used for this purpose. In certain cases, the audio signal may be received wirelessly while, in other cases, the audio signal may be input through a wire-connected audio jack. Input features can be used to select audio-control mode versus other control modes, such of control of frequency and power of vibration. In certain cases, input features can allow a user to select a particular audio signal from among multiple available audio signals. In certain implementations, audio control of a PVA may continue while the audio signal is present, following termination of which the PVA automatically returns to non-audio control. In other cases, specific user input controls initiation and termination of audio control of a PVA.

Once the audio control of the PVA has been selected, the input audio signal is continually processed and/or converted in step 2204. As one example, when the audio signal is an analog signal, the processing and conversion may apply a low-pass frequency filter to select only those frequencies compatible with audio control followed by removal of a direct-current signal component and, finally, analog-to-digital conversion. In other cases, an input digital audio signal can be used with low-pass filtering. Other types of signal processing can be carried out on either an input audio or digital signal. In general, these various types of signal processing are accompanied with a signal delay for processing results in a temporal offset of the input audio signal. In certain implementations, the PVA may be considered to output a delayed audio signal from the input audio signal that is temporally synchronized with audio control. In other words, the signal-processing delays are imparted to the input audio signal to generate a delayed audio signal in which those signal characteristics used to control vibration characteristics of the PVA are synchronized with those vibration characteristics. Next, in the while-loop of steps 2206-2210, the processed audio signal output from step 2204 is continuously monitored by control components of the PVA to generate control inputs to the LVM. In step 2207, the control components wait for a next control point. In general, control points are evenly spaced in time, with the interval between control points one-half or less than the interval between the highest-frequency characteristics of the audio signal from which control inputs are extracted. In other words, the frequency at which the audio signal is sampled and control output to the LVM is greater than or equal to twice the frequency of the highest-frequency characteristics of the audio signal extracted to generate control inputs to the LVM. In step 2208, the control components of the PVA compute a control value from the processed audio signal. In certain implementations, this control value is a value directly extracted from the instantaneous signal amplitude available at the control point. In other implementations, the control value is computed from all or a portion of the audio signal stored in memory since the previous control point. Many other types of control values may be generated from the current instantaneous signal, most recent stored portion of the signal, or even from larger portions of the audio signal stored over two or more previous control intervals. In step 2209, a control signal is output to the LVM based on, or corresponding to, the control value computed in step 2228. As one example, when the control value is related to the amplitude of a signal, the control value may be subject to thresholding based on high and low thresholds. When the control value is greater than or equal to a high threshold, a control signal may be sent to the LVM to drive the piston in a first direction. When the control value is less than or equal to the low threshold, then a signal is sent to the LVM to drive the piston in the opposite direction. When the control value is greater than the low threshold and less than the high threshold, no control signal is sent to the LVM at that control point. However, as with any type of signal processing, there are many different possible control values that can be obtained from analysis of the processed audio signal and a variety of different types of output signals or patterns of output signals that can be generated in response to particular control values. The while-loop of steps 2206-2210 continues until either the processed audio single is no longer available and/or a user inputs control inputs to the PVA to select non-audio control.

Again, the types of processing and conversion carried out in step 2204 may vary with different implementations as well as with different types of input audio signals. The order of the individual processing steps may also vary. The control signals output to the LVM may be simple control signals directing piston movement with an individual oscillation cycle or may be higher-level signals that direct the LVM to oscillate at a particular frequency and at a particular power over multiple cycles. In certain implementations, more than two thresholds may be used to select more than two temporally local vibration characteristics for each control period. Ultimately, an essentially limitless number of different control regimes can be output to the LVM based on any of an almost limitless number of extracted input-signal characteristics.

Although the present invention has been described in terms of particular embodiments, it is not intended that the invention be limited to these embodiments. Modifications within the spirit of the invention will be apparent to those skilled in the art. For example, the microprocessor or logic-circuit control may feature discrete operational settings from which a user can select a desired operational setting through a user interface. These settings may include vibrational-frequency-based settings, vibrational-force-based settings, and various different types of vibrational modes characterized by different types of temporal, frequency, and force patterns. Additional controls may allow a user to vary the vibrational power following selection of a discrete vibrational frequency setting or to select a vibrational frequency having first selected a discrete vibrational-power setting. Alternatively, the user interface may allow a user to navigate an entire two-dimensional surface or three-dimensional volume of operational characteristics. As discussed above, additional springs or other movable components may be included within an LVM in order to change the transfer function that describes the operational characteristics of a particular LVM setting. In certain implementations, various different types of sensors may be embedded within the PVA. The control component of the PVA may use the sensor input in order to adjust control of the PVA to achieve a variety of different predefined and user-defined goals. In certain implementations, multiple LVMs may be incorporated within a single PVA to provide an even wider range of operational characteristics. Various types of electronic or electromagnetic tags, such as RFID tags, may be incorporated within the PVA in order to facilitate detection of counterfeits or to associate the PVA with a particular user. In many implementations, the piston moves within air, but the piston chamber may be filled with other fluids or gasses in order to change the operational characteristics of the PVA. The position of the centering magnet within the inner housing may be adjusted to compensate for expected resistance during applications. Microprocessor-controlled PVAs may exchange significant amounts of information, during operation, with a personal computer, cell phone, or other remote electronic device. This would allow the PVA to operate according to more complex computer or mobile-phone resident exercise or training schedules and regimes. A PVA may be equipped with a variety of different types of sensors that allow the PVA to act as a general medical-sensor device, including sensors that allow the measurement of heart rate, blood pressure, blood oxygenation levels, temperature, and other such biological parameters. In addition to adjustments in the position of the centering magnet within the inner housing, various other types of components may be included in order to balance the load on the LVM in a variety of different applications.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A personal vibration appliance comprising:
an outer housing;
an internal channel;
a massage-piston that, when the personal vibration appliance is operated to apply a driving force to the massage-piston, linearly oscillates within the internal channel; and
control features that, when manipulated, power the personal vibration appliance on and off.

2. The personal vibration appliance of claim 1 wherein the massage piston includes a driving magnet that aligns with one or more centering components within the personal vibration appliance.

3. The personal vibration appliance of claim 2 wherein the one or more centering components are selected from among:
a centering magnet;
two centering magnets;
mechanical springs; and
one or more electromagnets.

4. The personal vibration appliance of claim 2 wherein two electrical coils wrap around the internal channel, one of the two electrical coils one each side of the centering magnet.

5. The personal vibration appliance of claim 2 wherein current is applied alternately to the two electrical coils in order to drive linear oscillation of the massage piston.

6. The personal vibration appliance of claim 2 wherein current is applied in different directions to the two electrical coils, and the direction of the current is changed at intervals in order to drive linear oscillation of the massage piston.

7. The personal vibration appliance of claim 1 further comprising an inner, bobbin-like housing that forms a central portion of the internal channel.

8. The personal vibration appliance of claim 6 wherein the inner, bobbin-like housing includes flux paths that lower the magnetic reluctance of the linear vibration module comprising the inner, bobbin-like housing and massage piston.

9. The personal vibration appliance of claim 1 wherein the massage piston is controlled, by control components within the personal vibration appliance, to oscillate at a frequency selected from within a frequency range 20 Hz to 350 Hz.

10. The personal vibration appliance of claim 9 wherein the massage piston is additionally controlled to produce a maximum vibrational force of between 2 g and 15 g when oscillating at a frequency in the frequency range 20 Hz to 350 Hz.

11. The personal vibration appliance of claim 1 further including one or more of:
a microprocessor control component; and
a logic-circuitry control component.

12. The personal vibration appliance of claim 10 wherein the one or more control components control operation of the personal vibration appliance by:
receiving control inputs through one or more control features; and
in response to the control inputs, selecting a control regime and controlling linear oscillation of the massage piston according to the selected control regime.

13. The personal vibration appliance of claim 12 wherein the control inputs specify one or more of:
a vibrational frequency;
a vibrational power;
a vibrational mode comprising a vibrational frequency and a vibrational power; and
a sequence of vibrational modes that comprises a composite vibrational regime.

14. The personal vibration appliance of claim 12 wherein the control regime may consist of continuously selecting one of a vibrational frequency, a vibrational power, a vibrational mode, and a composite vibrational regime in correspondence with one of an internally generated time-varying signal or an externally generated time-varying signal.

15. The personal vibration appliance of claim 13 wherein the time-varying signal is one of:
an audio signal; and
an audio/visual signal.

16. The personal vibration appliance of claim 11 wherein the control regime comprises control-component adjustment of one or more of:
duty-cycle adjustments;
adjustment of a voltage output from the power supply; and
adjustment of bias voltages on switching electronic components.

17. The personal vibration appliance of claim 1 wherein the massage piston is removable by application of mechanical force to one or both ends of the massage piston, allowing different types of massage pistons to be interchanged.

18. The personal vibration appliance of claim 1 wherein the tip of massage piston that extends from the first aperture is removable, allowing different types of massage tips to be interchanged.

19. The personal vibration appliance of claim 1 wherein linear oscillation of the massage piston is driven by one of:
wall power; and
an internal battery.

20. The personal vibration appliance of claim 1 wherein the massage piston includes internal, moveable subcomponents that effect the operational characteristics of the personal vibration appliance.

21. The personal vibration appliance of claim 1 further including a first aperture in the outer housing that interconnects the first aperture with the internal channel.

22. The personal vibration appliance of claim 21 wherein a tip of the massage piston protrudes from the first aperture.

23. The personal vibration appliance of claim 1 further including a second, funnel-shaped aperture that interconnects the second aperture with the internal channel.

24. The personal vibration appliance of claim 23 wherein the second aperture is covered with a flexible, compliant cover connected to the outer housing to seal the second aperture.

25. The personal vibration appliance of claim 24 wherein, with the first and second apertures covered, the personal vibration appliance can apply suction to the surface of a user's body as the massage-piston moves within the internal channel.

26. A personal vibration appliance comprising:
an outer housing;
an internal channel;
a moveable component that, when the personal vibration appliance is operated to apply a driving force to the moveable component, oscillates within the internal channel; and
control features that, when manipulated, power the personal vibration appliance on and off and select one or both of a vibrational frequency and a vibrational power.

27. A personal vibration appliance comprising:
an outer housing;
an internal channel;
a moveable component that, when the personal vibration appliance is operated to apply a driving force to the moveable component, oscillates within the internal channel at a vibrational frequency within a range of 20 Hz to 350 Hz in order to apply a force of between 0 g and 15 g to the moveable component.
